(19) United States
(12) Patent Application Publication
(10) Pub. No.: US 2016/0309278 A1
(43) Pub. Date: Oct. 20, 2016

(54) DETERMINING DOPPLER SHIFT IN AN AUDIO CHIRP SIGNAL

(71) Applicant: QUALCOMM Technologies International, Ltd., Cambridge (GB)

(72) Inventor: Paul HISCOCK, Cambridge (GB)

(21) Appl. No.: 14/686,373

(22) Filed: Apr. 14, 2015

(51) Int. Cl. H04S 7/00; G06F 3/16; H04R 5/04

(52) U.S. Cl. CPC H04S 7/302; H04R 5/04; G06F 3/165

(57) ABSTRACT

A method of determining Doppler shift of a received audio chirp signal, the received audio chirp signal having a receive frequency profile Doppler shifted relative to a transmit frequency profile that the received audio chirp signal was transmitted with. The method comprises: correlating the received audio chirp signal with a replica audio chirp signal to form a correlation output; identifying a relative alignment of the received audio chirp signal and the replica audio chirp signal to be that at which the received audio chirp signal and the replica audio chirp signal are most highly correlated; and determining the Doppler shift to be that corresponding to the identified relative alignment.

This invention relates to determining the Doppler shift of a received audio chirp signal.

### BACKGROUND

The increasing popularity of home entertainment systems is leading to higher expectations from the domestic market regarding the functionality, quality and adaptability of the associated speaker systems.

Surround sound systems are popular for use in the home to provide a more immersive experience than is provided by outputting sound from a single speaker alone. FIG. 1 illustrates the arrangement of a 5.1 surround sound system 100. This uses six speakers—front left 102, centre 104, front right 106, surround left 108, surround right 110 and a subwoofer 112. Each speaker plays out a different audio signal, so that the listener is presented with different sounds from different directions.

A microphone may be located in the surround sound system which receives audio codes from the speaker system. The microphone may be incorporated inside, for example, the listener's mobile phone or a games controller. The audio codes may relate to meta data which is being transmitted to the microphone device. The microphone device samples the received audio code and correlates those received audio code samples against replica audio codes in order to decode the received audio code. If either the speaker which transmitted the audio code or the microphone device which received the audio code is moving during the communication, then the received audio code is Doppler shifted relative to the transmitted audio code. This causes an apparent change in sample rate, which leads to the samples of the received audio code no longer being aligned with those of the replica audio code, and hence the correlation of the received audio code and its matching replica audio code is degraded.

Thus, there is a need for a technique of improving the ability to accurately decode Doppler shifted audio codes when the Doppler shift is unknown to the receiver.

### SUMMARY OF THE INVENTION

According to a first aspect, there is provided a method of determining Doppler shift of a received audio chirp signal, the received audio chirp signal having a receive frequency profile Doppler shifted relative to a transmit frequency profile that the received audio chirp signal was transmitted with, the method comprising: correlating the received audio chirp signal with a replica audio chirp signal to form a correlation output; identifying a relative alignment of the received audio chirp signal and the replica audio chirp signal to be that at which the received audio chirp signal and the replica audio chirp signal are most highly correlated; and determining the Doppler shift to be that corresponding to the identified relative alignment.

The received audio chirp signal comprises a Zadoff-Chu code, and the replica audio chirp signal comprises a Zadoff-Chu code.

The method may comprise: storing a model profile, the model profile associating a Doppler shift with each relative alignment between a received audio chirp signal and a replica audio chirp signal; and determining the Doppler shift based on the model profile.

Suitably, the received audio chirp signal has a gradient and a number of samples N, the method comprising: identifying the relative alignment of the received audio chirp signal and the replica audio chirp signal to be the correlation peak index of the largest correlation peak in the correlation output; and determining the Doppler shift by multiplying the correlation peak index by the gradient modulo N.

Suitably, the received audio chirp signal has a gradient and a number of samples N, the method comprising: identifying the relative alignment of the received audio chirp signal and the replica audio chirp signal by: identifying a primary group of correlation peak indices comprising the largest correlation peak in the correlation output; identifying neighbouring groups of correlation peak indices adjacent to the primary group of correlation peak indices; determining a fractional Doppler shift from the magnitude of the largest correlation peak in the primary group and the magnitudes of the largest correlation peaks in the neighbouring groups; determining an integer Doppler shift by multiplying the correlation peak index of the largest correlation peak in the primary group by the gradient modulo N; and determining the Doppler shift by adding the fractional Doppler shift to the integer Doppler shift.

The replica audio chirp signal may have the transmit frequency profile. Alternatively, the replica audio chirp signal may have a frequency profile shifted from the transmit frequency profile.

Suitably, the method comprises: correlating the received audio chirp signal with a plurality of replica audio chirp signals, each replica audio chirp signal having a frequency profile shifted from the other replica audio chirp signals; identifying the replica audio chirp signal with which the received audio chirp signal is most highly correlated; identifying the relative alignment of the received audio chirp signal and the identified replica audio chirp signal which are most highly correlated; and determining the Doppler shift to be the Doppler shift corresponding to the identified replica audio chirp signal and the identified relative alignment.

The method may further comprise, prior to receiving the received audio chirp signal: receiving a non-Doppler shifted calibration chirp signal; correlating the non-Doppler shifted calibration chirp signal with a replica chirp signal to form a calibration correlation output; adjusting the timing with which subsequent chirp signals are sampled based on the calibration correlation output such that if a subsequent chirp signal is not Doppler-shifted, then when that subsequent chirp signal is correlated against a replica chirp signal the largest correlation peak of that correlation is at a known correlation peak index.

Suitably, the method further comprises detecting movement of a transmitter relative to a receiver from the Doppler shift.

Suitably, the method further comprises: storing instructions associated with movements; comparing the detected movement of the transmitter to the movements in the store, thereby identifying a corresponding instruction; and performing the identified instruction.

Performing the identified instruction may comprise modifying a parameter of the receiver. Performing the identified instruction may comprise modifying the volume at which the receiver plays out audio signals.

Suitably, the received audio chirp signal comprises a chirp identifier which identifies the device which transmitted the received audio chirp signal.

The method may further comprise correcting a subsequently received audio chirp signal for the determined Doppler shift to form a Doppler-corrected subsequently received audio chirp signal.

The method may further comprise determining the distance between the device which transmitted the subsequently received audio chirp signal and the device which received the subsequently received audio chirp signal using the Doppler-corrected subsequently received audio chirp signal.

According to a second aspect, there is provided chirp device configured to determine the Doppler shift of a received audio chirp signal, the received audio chirp signal having a receive frequency profile Doppler shifted relative to a transmit frequency profile that the received audio chirp signal was transmitted with, the chirp device configured to: correlate the received audio chirp signal with a replica audio chirp signal to form a correlation output; identify a relative alignment of the received audio chirp signal and the replica audio chirp signal to be that at which the received audio chirp signal and the replica audio chirp signal are most highly correlated; and determine the Doppler shift to be that corresponding to the identified relative alignment.

### BRIEF DESCRIPTION OF THE DRAWINGS

The present invention will now be described by way of example with reference to the accompanying drawings. In the drawings:

FIG. 1 illustrates a 5.1 surround sound system;

FIGS. 2a and 2b illustrate the dependence of correlation on Doppler for an M-sequence audio code;

FIG. 3 illustrates a correlation response for a non-Doppler shifted M-sequence replica code and for several Doppler shifted M-sequence replica codes;

FIG. 4 illustrates the frequency spectrum of an audio code;

FIGS. 5a and 5b illustrate the dependence of correlation on Doppler for a chirp audio code;

FIG. 6 illustrates a correlation response for a non-Doppler shifted replica chirp audio code and for a Doppler shifted replica chirp audio code;

FIG. 7 illustrates a schematic diagram of the exemplary components of a chirp receiver;

FIG. 8 is a flowchart illustrating a method of determining Doppler shift of a received audio chirp signal; and

FIG. 9 illustrates an exemplary receiver.

### DETAILED DESCRIPTION

The following description is presented to enable any person skilled in the art to make and use the invention, and is provided in the context of a particular application. Various modifications to the disclosed embodiments will be readily apparent to those skilled in the art. The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

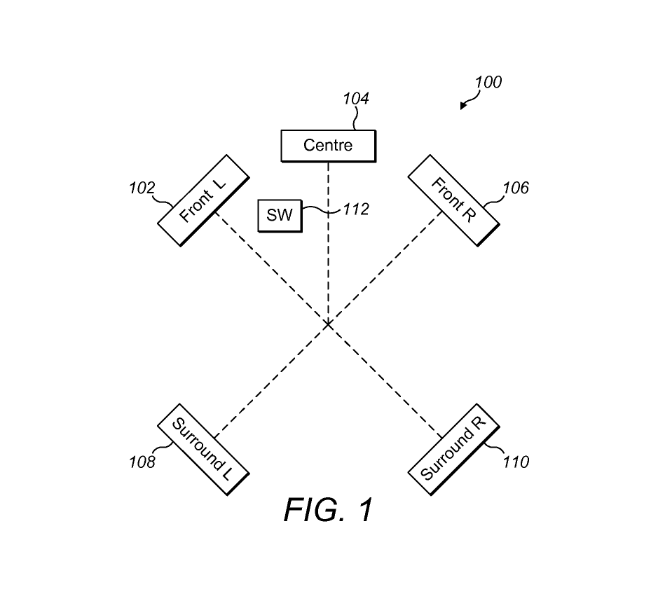

Suitably, long correlating codes are used to communicate meta-data in an audio application, such as in the speaker system of FIG. 1. This is because long correlating codes provide greater coding gain than shorter correlating codes, and hence they are able to be sent at a lower power which reduces the likelihood of them being heard by people. For example, codes of 50 ms in length and 10 kHz in bandwidth in the audio spectrum are unlikely to be detected by people. However, the longer the correlating code, the greater the misalignment of the received audio codes and the replica audio codes due to Doppler shift as discussed above.

An example of a long correlating code which is unlikely to be detected by people is a 511 sample M-sequence. Consider a speaker transmitting an audio signal comprising an M-sequence audio code. The audio signal is received by a microphone. When either the microphone or the speaker is moved parallel to a straight line connecting the two, the audio signal received at the microphone is Doppler shifted relative to the audio signal transmitted by the speaker. This has the effect of scaling all the frequency components of the received audio code. If the movement is so as to cause the microphone/speaker to become closer to each other, then the frequency components in the audio code are increased. If the movement is so as to cause the microphone/speaker to become further apart, then the frequency components in the audio code are decreased. This causes a misalignment between the received audio code samples and the corresponding samples of the replica audio code that the receiver correlates the received audio code samples with.

It can be envisaged that the movement may be caused by a user holding a device into which the microphone is incorporated, and moving it. For example, the user may be holding a games controller which incorporates the microphone. As another example, the user may be walking holding their mobile phone which incorporates the microphone. Average walking pace is about 1.5 m/s. Movement of a games controller may be significantly faster, for example 5 m/s.

Consider a movement of just 0.34 m/s, which is considerably slower than may be expected in the applications above. If the microphone is moved at a rate of 0.34 m/s towards the speaker, then the effective sample rate of the audio signal comprising the audio code is scaled by 1-0.34/340, which is a change of about 0.1%. This has the effect of scaling all the frequencies in the audio code by 1.001. The frequency offset caused by the Doppler shift is not fixed across the bandwidth of the signal. The frequency offset is frequency dependent. The frequency offset is greater for higher frequencies. For example, for an audio code that spans 5 kHz to 15 kHz, the lower parts of the frequency spectrum of the audio code are increased by ˜5 Hz, whereas the upper parts of the frequency spectrum of the audio code are increased by ˜15 Hz.

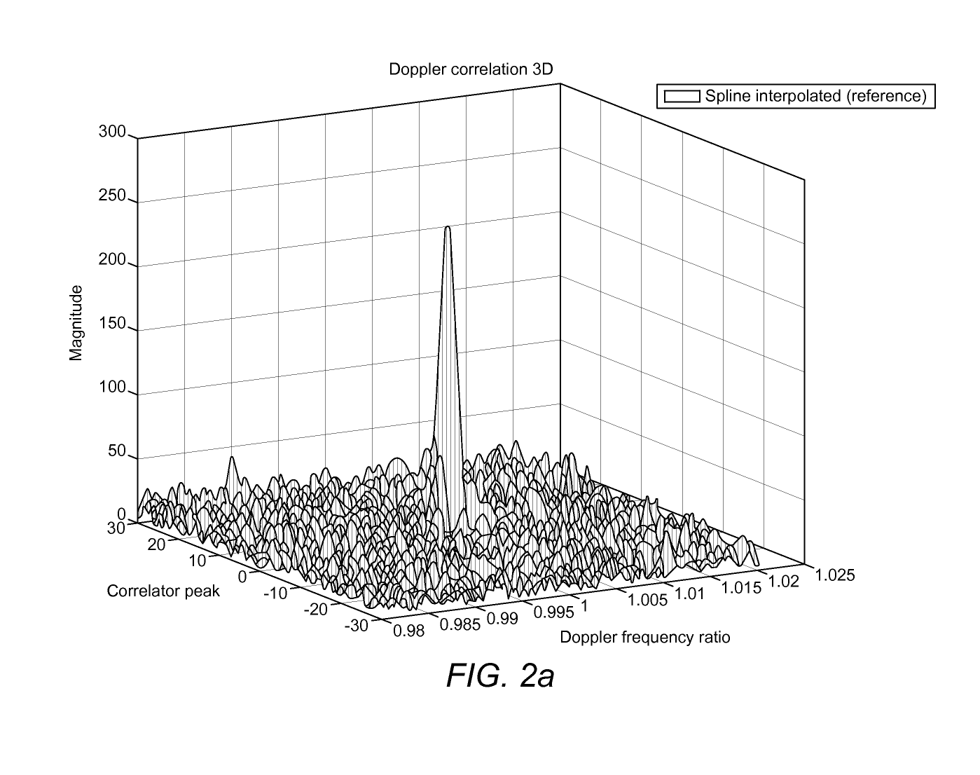

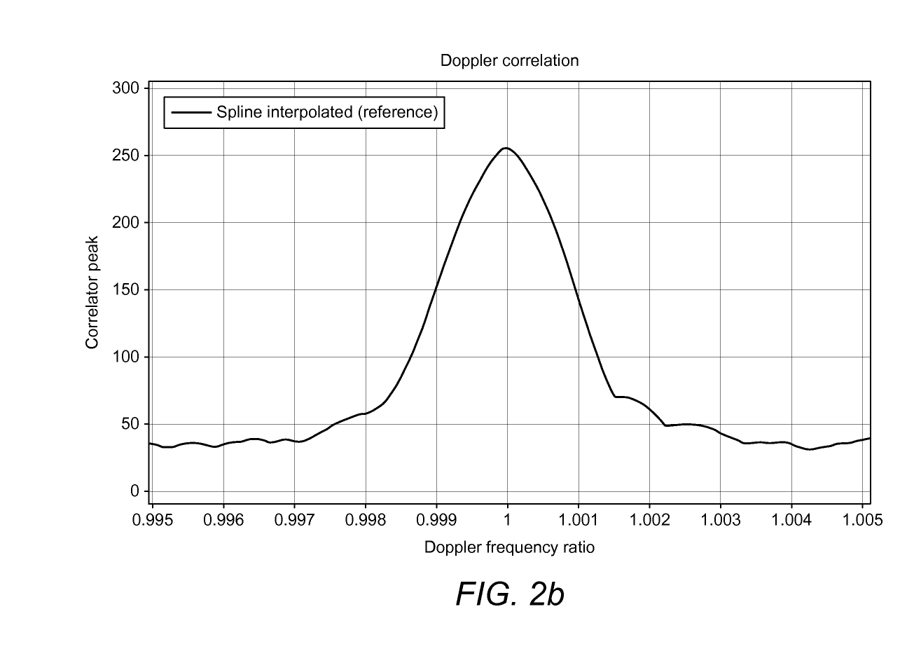

FIGS. 2a and 2b illustrate a simulation of these effects on a length 511 M-sequence which is transmitted having a ˜11 kHz bandwidth, at a sample rate of 44.1 kHz and a centre frequency of 10 kHz, and which is received by a detector at various Doppler shifts. The received audio code is correlated against a replica audio code which matches the transmitted audio code. FIG. 2a illustrates Doppler ratio against correlation peak index. FIG. 2b illustrates the maximum correlation peak for a given Doppler ratio. As expected, the maximum correlation peak is at a Doppler ratio of 1. In other words, the received audio code correlates most highly with the replica audio code when the received audio code is not Doppler shifted relative to the transmitted audio code. The level of the correlation between the received audio code and the replica audio code falls off rapidly as Doppler shift is introduced to the received audio code. By ±1.001 Doppler frequency ratio, which is equivalent to ±0.1% variation in sample rate, which equates to a velocity of about 0.34 m/s, the correlation has reduced to 60% of its peak value. This is about a 3 dB correlation loss compared to the peak value. Thus, even at velocities of a fraction of walking pace, severe correlation loss is caused by the Doppler shift.

Since the Doppler shift causes the audio code to be subjected to a frequency offset which is proportional to the frequency components in the code, a simple frequency adjustment to the replica audio code cannot be made which would cause the adjusted replica audio code to correlate well with the Doppler shifted received audio code, and hence thereby enable the Doppler shifted M-sequence audio code to be better detected.

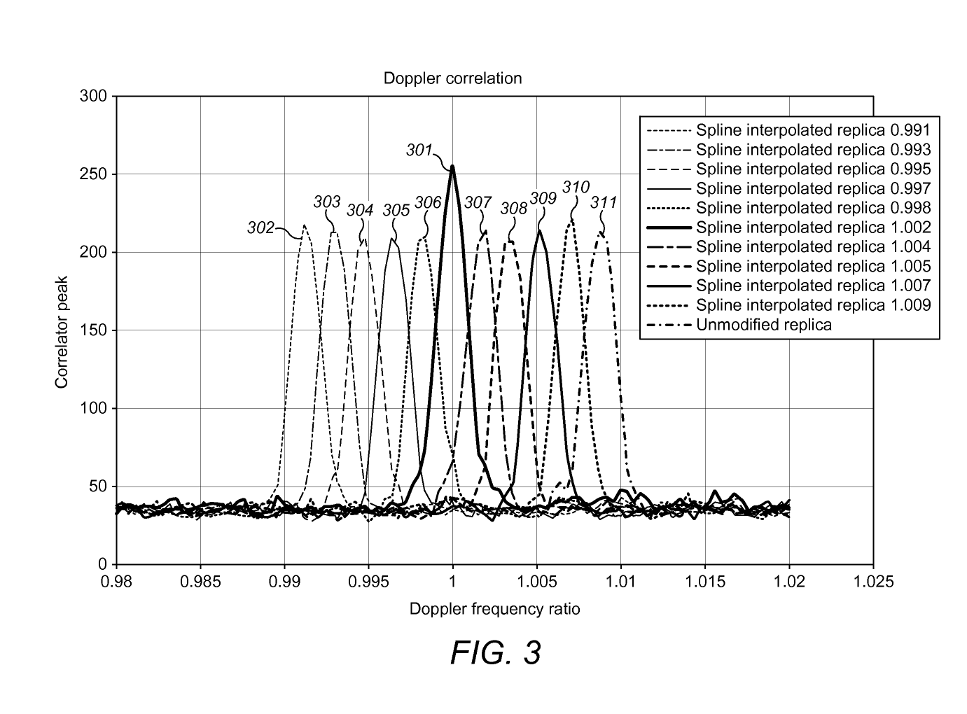

FIG. 3 shows how this limited range can be extended to cover −1% to +1% by using ten additional replicas made from suitably Doppler-shifted M-sequences. Plot 301 is a copy of the plot in FIG. 2b and represents the peak correlator response of a zero Doppler-shifted M-sequence replica in response to a range of Doppler-shifted audio codes. Plots 302 to 311 show the maximum response of 10 further correlator outputs created using a set of 10 Doppler-shifted M-sequences separated by Doppler shifts of 0.00175. In order to cover this range 11 correlations are required in total. From these 11 sets of correlator results the maximum overall correlator result determines which Doppler offset was found. Although this is a reasonable approach to detecting a wider range of Doppler, multiple correlations are required, and with 11 sets to choose from, and in the presence of noise, there is a chance the wrong peak will be selected. Covering this useful working range using only a single correlation would be better.

Another example of a long correlating code which is unlikely to be detected by people is a Gold code. Gold codes are sensitive to Doppler shift in the same manner described above for M-sequences. As with M-sequences, correlating a received audio code with Doppler shifted replica audio gold codes does not enable accurate detection of similarly affected received audio codes.

A further example of a long correlating code which is unlikely to be detected by people is a chirp code. An exemplary chirp code is a Zadoff-Chu code. The following describes an example of how a chirp code may be used to construct an audible code. The transmitted audio signal is sampled at Ft Hz and contains a chirp code comprising N samples in a bandwidth of B Hz, with a centre frequency of Fc Hz, where

$${F}_{C} - \frac{B}{2} > 0$$

$$and$$

$${F}_{C} + \frac{B}{2} < \frac{{F}_{t}}{2} .$$

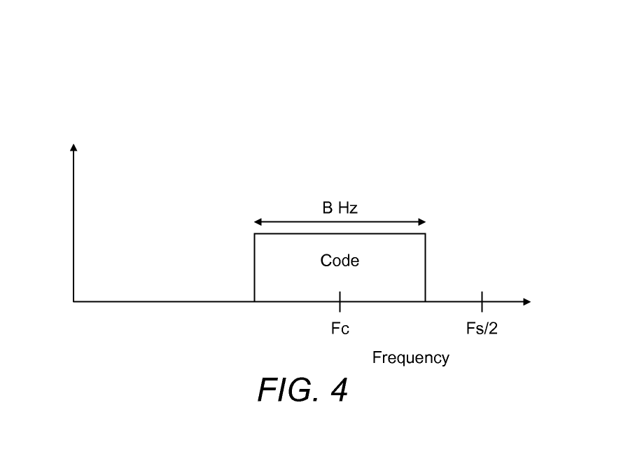

This is illustrated in FIG. 4, where the sample rate Fs=Ft. A chirp code, having samples denoted by n, and total length N samples where n=0 . . . N−1, with a frequency gradient of g, is defined by the equation,

$${W}_{g} ( n ) = \{ \begin{matrix}{e}^{\frac{j π}{N} gn ( n + 1 )} & N odd \\ {e}^{\frac{j π}{N} {gn}^{2}} & N even\end{matrix} \qquad ( equation 1 )$$

This chirp code is processed into order to construct a real valued signal in a band-pass part of the audio spectrum. The chirp code is first oversampled, for example using interpolation. The following equation defines a linearly interpolated chirp code, Wig(m) which has been linearly oversampled by a factor K to give a sequence of M=KN samples.

$${W}_{ig} ( m ) = α {W}_{g} ( n + 1 ) + ( 1 - α ) {W}_{g} ( n ) \vert \begin{matrix}m = 0 … KN - 1 \\ n = ⌊ \frac{m}{K} ⌋ \\ α = \frac{m - Kn}{K}\end{matrix} \qquad ( equation 2 )$$

Other techniques are possible. For example, spline interpolation may be used to oversample the chirp code. The chirp code may also be constructed through the frequency domain and integrated to get phase.

The interpolated chirp code is them mixed up to the transmit frequency Fc, for example by multiplication by a complex exponential. The real part of the mixed up signal is then taken. This process creates an audio chirp code, Wag(m) which is suitable for transmission:

$${W}_{ag} ( m ) = Re [ {W}_{ig} ( m ) {e}^{\frac{2 j π {F}_{c} m}{{F}_{t}}} ] m = 0 … M - 1 \qquad ( equation 3 )$$

Wag(m) is an audio chirp code having the properties shown in FIG. 4. Audio chirp code, Wag(m), may be incorporated into another audio signal for transmission, or may be transmitted on its own. A continuous time version Tx(t) of the audio chirp signal to be transmitted is created by passing Wag(m) through a digital to analogue converter followed by an analogue low-pass filter. The audio chirp signal is then transmitted.

The transmitted audio chirp signal becomes Doppler shifted as described above if there is relative movement of the transmitter and receiver in the direction of each other. Consider that the receiver moves at a velocity of vm m/s in the direction of the transmitter. The analogue to digital converter in the receiver samples the received analogue waveform at the same rate as the transmitter, because they are synchronised. Hence, the receiver collects samples Rx(m) from the ADC according to:

$$Rx ( m ) = Tx ( \frac{{v}_{c} + {v}_{m}}{{v}_{c}} mT ) \qquad ( equation 4 )$$

where m is the sample index, T is the receiver sample period, Fr is the receive sample rate, and

$$T = \frac{1}{{F}_{r}} .$$

The fraction term

$$\frac{{v}_{m}}{{v}_{c}}$$

is the Doppler shift, ds, and can be expressed as a percentage. As mentioned above the receiver samples the received signal at a sample rate Fr which is the same as the transmitter sampling rate Ft. The digital sequence Rx(m) contains a band limited code. This is mixed down to centre the code at DC, for example by multiplication with a complex exponential. It is then low pass filtered. The low pass filter has a pass bandwidth which is equal to the code bandwidth. This results in a complex signal, Rxc(m) given by:

$${Rx}_{c} ( m ) = LPF [ Rx ( m ) {e}^{\frac{2 j π {F}_{c} m}{{F}_{t}}} ] \vert m = 0 … NK - 1 \qquad ( equation 5 )$$

The code bandwidth

$${Bw}_{c} = \frac{{F}_{r}}{K} .$$

Rxc(m) contains the audio code and also any other background noise in the code's spectral band, and is oversampled by the factor K. Since the signal has been low pass filtered, it can be decimated by K to give Rxd(n) given by:

Rx_{d}(n)=Rx_{c}(Kn)|_{n=0 . . . N-1} (equation 6)

The processed signal Rxd(n) is suitable for being correlated against the replica chirp code. The replica chirp code can be represented by Wg(n). The processed received audio chirp signal Rxd(n) may be correlated against the replica chirp code Wg(n) using fast fourier transforms (FFT). This results in a correlator output Co(b) given by:

Co=|iFFT(FFT(Rx_{d}).conj(FFT(W_{g})))| (equation 7)

where Co is the correlator output array and b is the correlator bin or index value and is circular, so that Co(b+kN)=Co(b),k∈ [symbol] .

If the received audio chirp code is time aligned with the replica chirp code such that the first received sample of the audio chirp code is at n=0, and the received audio chirp code is not Doppler shifted relative to the transmitted audio chirp code, and there is no significant background noise, then Co(0) will have the maximum correlation peak and the other correlator bins will contain lower values.

The magnitude of the correlator response Co(n) from a Zadoff-Chu code, of length N and gradient g, sampled at Fs Hz, that has been frequency shifted by

$$f \frac{Fs}{N} Hz ,$$

is given by:

$$Co ( n ) = \vert \frac{sin ( π ( f - gn ) )}{N sin ( \frac{π}{N} ( f - gn ) )} \vert n = 0 … N - 1 \qquad ( equation 8 )$$

For integer values of f, g and n this expression is zero except when f+gn=0(mod N). Hence, n is a peak at nₚₖ:

nₚₖ=−g⁻¹f(mod N) (equation 9)

Where “−1” here means reciprocal inverse.

An audio chirp code (for example length 521) that is centred at Fc Hz (for example 10 kHz), and subject to an absolute Doppler shift ds of less than approximately 1%, can be approximated to be a chirp that has been frequency shifted by ds. Fc Hz. Hence, from equation 9, and assuming that the modulo N can be managed, the Doppler shift can be approximated to be:

$$ds \tilde{=} - {gn}_{pk} \cdot \frac{Fs}{N . Fc} \qquad ( equation 10 )$$

Where, from the previous discussion,

$$f = \frac{N . ds . Fc}{Fs} .$$

Fs, Fc, N and g are all known to the receiver. Thus, by identifying the location npk of the maximum correlation peak, the Doppler shift is determined according to equation 10.

Equation 9 is defined in terms of integers and so nₚₖ and g⁻¹ are integers and

$$\frac{Fs}{N . Fc}$$

is a constant. Hence, equation 9 suggests that as the frequency term f changes by integer amounts, the Doppler shift changes in steps and the peak in the correlator output moves in steps of g⁻¹ bins. In practice, non-integer values off and larger values of ds may cause two or more neighbouring groups of peaks to occur centred near to bins that are multiples of g⁻¹. For example, groups of peaks may be found around bins (G−1).g⁻¹,G.g⁻¹ and (G+1).g⁻¹. Where G is the group number and is a small integer compared to N, for example G<√N, and group G contains the largest magnitude correlator peak. By suitable selection of the gradient g the groups of peaks do not overlap, which allows large magnitude peaks to be unambiguously associated with a particular group. In practice, the largest peak in a group may not be at the centre of the group and its index value in the correlator output may not be a small multiple of g⁻¹. For example, if the largest and true peak was expected at correlator index G.g⁻¹, the actual largest peak could be anywhere in a range of index values either side of G.g⁻¹. For example from index G.g⁻¹−K to G.g⁻¹+K. For the example under consideration a suitable value for K is 6. Alternatively, a range of suitable relative index values R can be determined experimentally. The group G is defined in terms of its relative index values and contains the index G.g⁻¹. The group number G, that contains the largest overall correlator peak, determines the integer part of Doppler shift.

The fractional part of the Doppler shift F can be estimated from the magnitudes of the correlator peaks in the groups G−1, G and G+1. For example, linear interpolation can be used to obtain the fractional part using equation 11.

$${P}_{e} = max [ Co ( ( G - 1 ) {g}^{- 1} + R ) ] \\ {P}_{l} = max [ Co ( ( G + 1 ) {g}^{- 1} + R ) ] \\ F = \{ \begin{matrix}- \frac{- {P}_{e}}{{P}_{p} + {P}_{e}} & {P}_{e} > {P}_{l} \\ \frac{{P}_{l}}{{P}_{p} + {P}_{l}} & {P}_{e} \leq {P}_{l}\end{matrix} \qquad ( equation 11 )$$

Where Pₚ is the maximum correlator peak value and R is an array of relative index values that define the group as described above. The overall estimate for the fractional Doppler shift ds is given by equation 12.

$$ds \tilde{=} - ( G + F ) \cdot \frac{Fs}{N . Fc} \qquad ( equation 12 )$$

As the Doppler shift moves beyond 1% more correlation peaks are observed. Suitably, training profiles are stored, each of which maps a set of correlation peaks to a value of ds. Each training profile may comprise any combination of the following parameters: number of correlation peaks, correlation peak indices of the correlation peaks, magnitude of the correlation peaks, phase of the correlation peaks. The observed correlation response is compared to the training profiles. The training profile that matches the observed correlation response with least error determines the best estimate of ds.

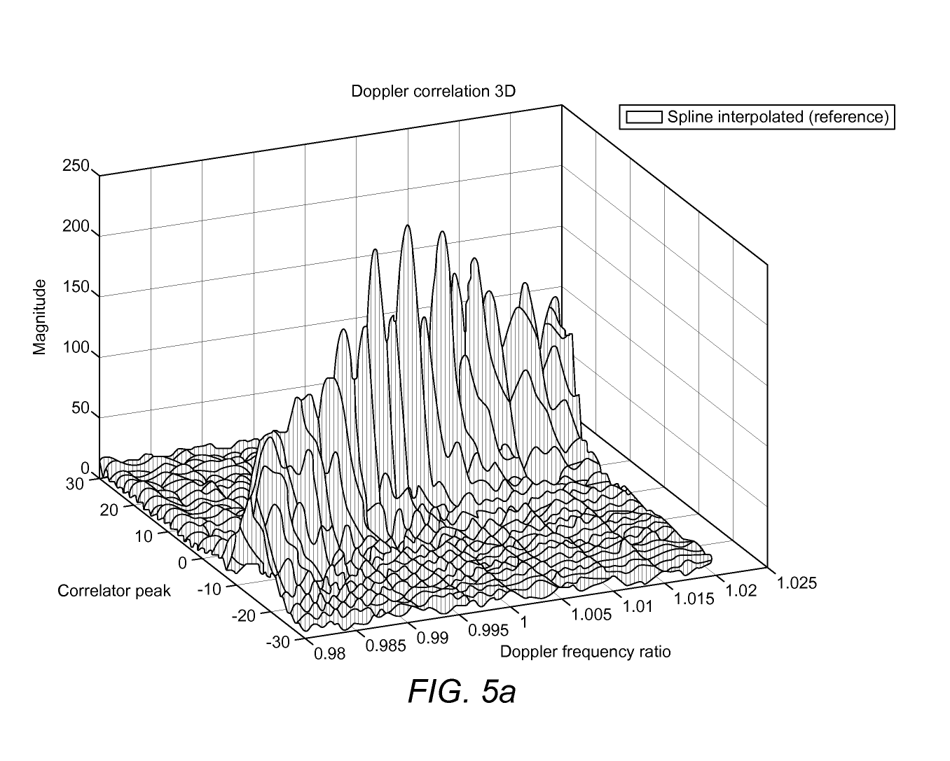

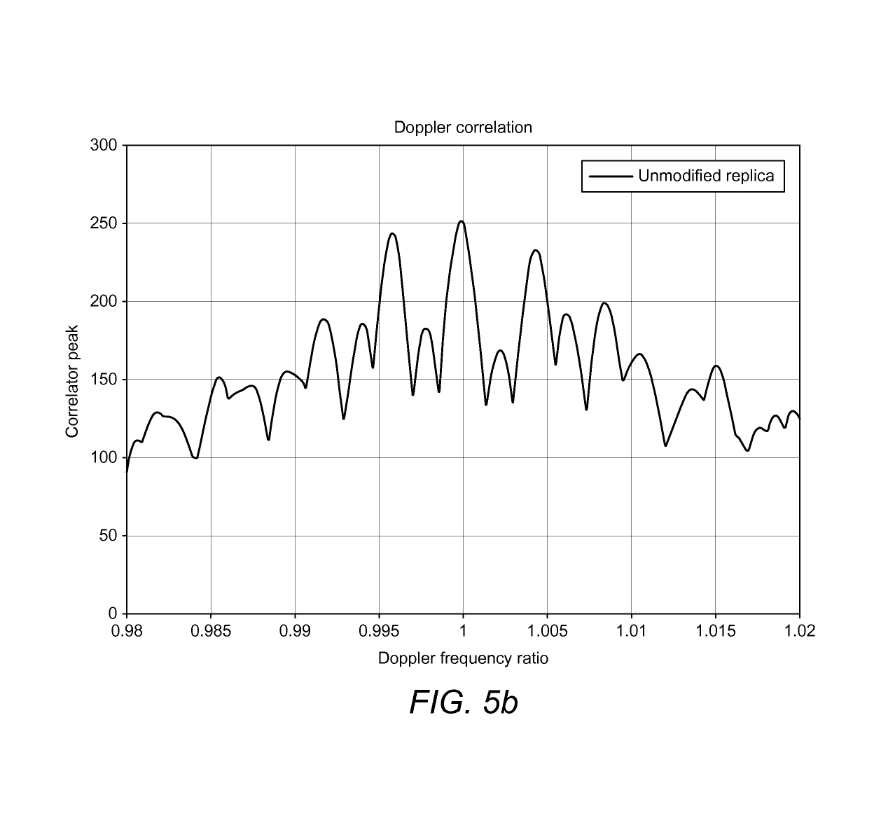

FIGS. 5a and 5b illustrate a simulation of the effect of Doppler shift on a length 521 Zadoff-Chu code which is transmitted having a gradient g=1, a ˜11 kHz bandwidth, at a sample rate of 44.1 kHz and a centre frequency of 10 kHz, and which is received by a detector at various Doppler shifts. This is the same simulation configuration as for FIGS. 2a and 2b, except that a 521 length Zadoff-Chu code is used instead of a length 511 M-sequence. The received audio chirp code is correlated against a replica audio chirp code which matches the transmitted audio chirp code. As described in the last paragraph, when the received audio chirp code is not Doppler shifted, it is time aligned with the replica audio chirp code, such that the first received sample of the received audio chirp code is at n=0.

FIG. 5a illustrates Doppler ratio against correlation peak index. FIG. 5b illustrates the maximum correlation peak for a given Doppler ratio. As expected, the maximum correlation peak is at a Doppler ratio of 1. In other words, the received audio code correlates most highly with the replica audio code when the received audio code is not Doppler shifted relative to the transmitted audio code. As illustrated on FIG. 5a, for a non-Doppler shifted received audio code (having a Doppler ratio of 1), the maximum correlation peak is at correlation index position 0.

Unlike FIGS. 2a and 2b, the replica audio code correlates significantly with received audio codes with Doppler shifts of up to about ±1%. This is illustrated on FIG. 5b, in which the correlator peaks remain at ˜60% of the highest correlator peak up to Doppler shifts of about ±1%. Thus, the correlation response remains sensitive to detection of received audio chirp signals that are Doppler shifted by a factor of 10 greater than the sensitivity of the correlation response using M-sequences or Gold codes. Hence, the use of Zadoff-Chu codes has reduced the processing requirements by a factor of 10 compared to M-sequences.

FIG. 5a illustrates how the amount by which a received audio chirp code has been Doppler shifted from the transmitted audio chirp code can be measured. As can be seen from FIG. 5a, as the Doppler ratio increases from 1, the correlator peak bin having the maximum magnitude decreases. Conversely, as the Doppler ratio decreases from 1, the correlator peak bin having the maximum magnitude increases. In FIG. 5a, 20 correlator bins span Doppler shifts of about −1% Doppler shift to +1% Doppler shift. This equates to a speed offset from −3.4 m/s to +3.4 m/s, with a resolution of 0.34 m/s.

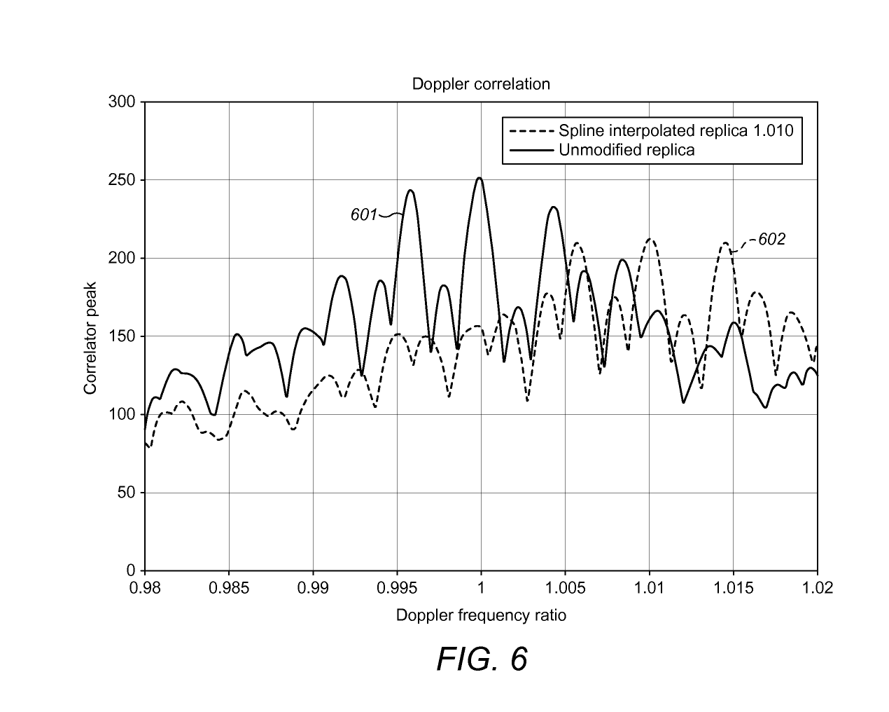

In order to accurately detect a received audio chirp code having a Doppler shift greater than 1%, the received audio chirp code can be correlated with each of a set of replica audio chirp codes. Each replica audio chirp code is already Doppler-shifted relative to the transmitted audio chirp code by a set amount. For example, one replica audio chirp code may be shifted by 1% from the transmitted audio chirp code, the next replica audio chirp code may be shifted by 1.5% from the transmitted audio chirp code, and so on. FIG. 6 illustrates two correlation responses Zadoff-Chu audio chirp codes. The correlation response marked 601 is the same as that shown in FIG. 5b, which is when a replica audio chirp code which is the same as the transmitted audio chirp code is correlated against a received audio chirp code having a given Doppler shift (where Doppler shift is on the x-axis, and the amplitude of the correlation peak is on the y-axis). The correlation response marked 602 is when a replica audio chirp code which is shifted from the transmitted audio chirp code by 1% is correlated against a received audio chirp code having a given Doppler shift. Unlike the correlation response using the M-sequence replica chirp codes of FIG. 2, which only cover a 0.1% range, the correlation response of FIG. 6 has significant correlation peak over a range of 1% s. Thus, utilising Doppler shifted replica audio chirp codes enables detection of similarly affected received audio chirp codes using far fewer correlations. For example, received audio chirp codes which are Doppler shifted relative to the transmitted audio chirp code by more than 1% can be detected. Interpolation using the magnitudes of neighbouring peaks may be used to approximate fractional values of ds. Further correlations may be performed having a finer granularity on the shift of the replica audio chirp code, in order to more accurately determine the Doppler shift of the received audio chirp code. For example, correlations may be performed with replica audio chirp codes shifted by 1.01%, 1.02%, 1.03% etc.

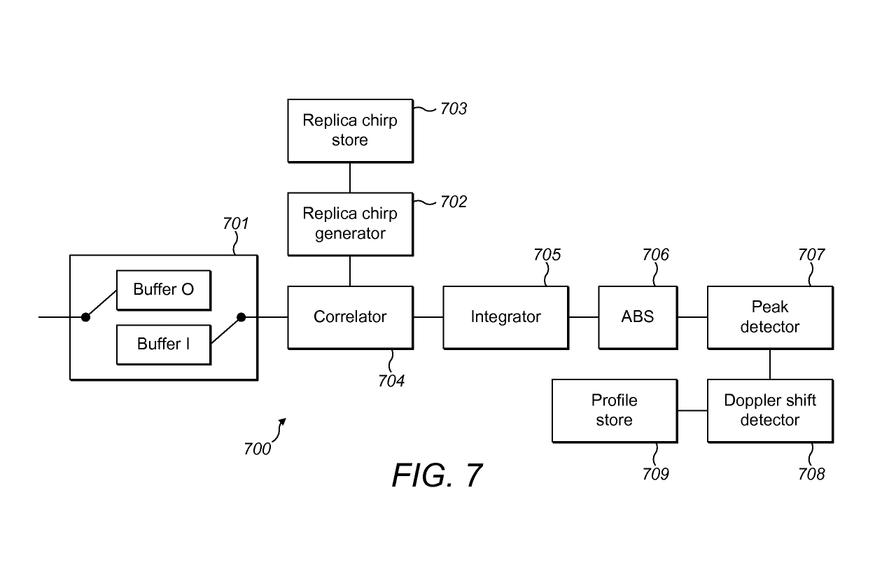

Reference is now made to FIG. 7 which is a schematic diagram of the exemplary components of a chirp receiver 700. An audio chirp signal is received at the chirp receiver and sampled at the receiver sampling rate Fr, which is the same as the transmitter sampling rate Ft. Suitably, the received audio chirp samples are input to the buffer module 701. Suitably, buffer module 701 comprises two buffers. This enables an input buffer to be receiving samples whilst the output buffer is being read. When the input buffer becomes full, the two buffers are swapped over so that input samples can continue to be stored without loss. The output buffers may be read multiple times, for example if the received audio chirp code is to be correlated with each of a set of replica audio chirp codes. The received audio chirp samples output from the buffer module 701 are input to correlator 704.

Replica chirp generator 702 generates a replica audio chirp code to correlate with the received audio chirp code. The replica chirp generator 702 may do this by extracting the replica audio chirp code from the replica chirp store 703. Correlator 704 correlates the received audio chirp code and the replica audio chirp code. It does this by multiplying the received audio chirp code with the conjugate of the replica audio chirp code. The correlator 704 may correlate the received audio chirp code with the replica audio chirp code using a fast fourier transform method according to equation 7. Alternatively, the correlator 704 may correlate the received audio chirp code with the replica audio chirp code utilising a circular shift register and a set of complex multipliers. For each successive correlation, the circular shift register shifts the audio chirp code by one sample, and the set of complex multipliers multiply each of the audio chirp code samples by a corresponding sample of the replica audio chirp code. The resulting set of correlation samples are added to form the correlation output.

Suitably, the output of correlator 704 is input to integrator 705. Integrator 705 is a complex integrator. In the case that a plurality of audio chirps have been received which are all identical, the integrator 705 coherently integrates the correlator outputs of each of the identical chirps. The output of the integrator 705 is input to an absolute value unit 706. The absolute value unit outputs the magnitude of the complex coherent integration. Peak detector 707 then identifies the maximum correlation peaks in the correlation response. The peak detector 707 outputs the correlation bin index of the maximum correlation peak in the correlation response. Doppler shift detector 708 determines the Doppler shift of the received audio chirp signal from the correlator bin index of the maximum correlation peak in the correlation response. The Doppler shift detector 708 may do this with reference to profile store 709. Profile store 709 stores a correspondence between maximum correlation peak bin index and Doppler shift. Suitably, the correspondences stored in the profile store 709 are predetermined For example, the correspondences may have been determined from simulation, for example as shown in FIG. 5a. Alternatively, the correspondences may have been empirically determined. The Doppler shift detector 708 may access the profile store 709 to look up the Doppler shift which corresponds to the maximum correlation peak index received from peak detector 707. This is then the determined Doppler shift for that received audio chirp code. Alternatively, the Doppler shift detector 708 may determine the Doppler shift of the received audio chirp signal to be the correlator bin index of the maximum correlation peak as received from the peak detector 707 multiplied by the gradient of the received audio chirp signal modulo the chirp length N in accordance with equation 10.

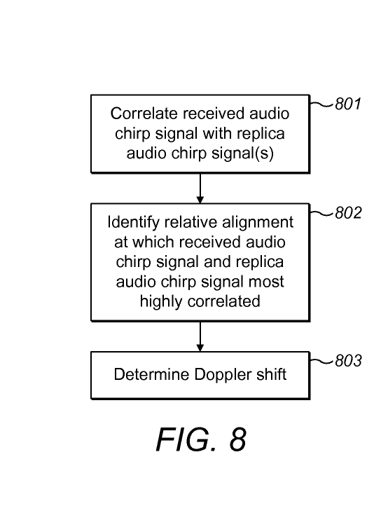

FIG. 8 illustrates a method of determining the Doppler shift of a received audio chirp signal. At step 801, the received audio chirp signal is correlated with a replica audio chirp signal. The replica audio chirp signal may match the transmitted audio chirp signal. In other words, the replica audio chirp signal may have no Doppler shift relative to the transmitted audio chirp signal. The correlation involves multiplying the N samples of the received audio chirp signal with the N samples of the replica audio chirp signal. The correlation response shown in FIG. 5b is formed from the results of a set of correlations. Each correlation involves multiplying a time shifted version of the N samples of the received audio chirp signal against the replica audio chirp signal (or conversely multiplying the N samples of the received audio chirp signal against time shifted versions of the N samples of the replica audio chirp signal).

At step 802, a relative alignment of the received audio chirp signal and the replica audio chirp signal at which the received audio chirp signal and the replica audio chirp signal are most highly correlated is identified. If the received audio chirp signal and the replica audio chirp signal are time aligned and the received audio chirp signal is not Doppler shifted, then the highest correlation peak is at correlation peak index 0. This is Co(0) in equation 7. Identification of the correlation peak index of the maximum magnitude correlation peak is indicative of a relative alignment between the received audio chirp signal and the replica audio chirp signal.

At step 803, the Doppler shift of the received audio chirp signal is determined. This may be determined with reference to the model profile store 709 as discussed above. In this case, the model profile store stores a Doppler shift corresponding to each correlation peak index for the case that the received audio chirp signal and the replica audio chirp signal are time aligned. Thus, the correlation peak index of the maximum magnitude correlation peak identified at step 802 is looked up in the model profile store, and the associated Doppler shift is determined to be the Doppler shift of the received audio chirp signal. Alternatively, the Doppler shift is determined by diving the correlation peak index by the gradient of the received audio chirp signal, in accordance with equation 10.

Suitably, the received audio chirp signal and the replica audio chirp signal are time-aligned prior to the correlation of step 801. This enables the Doppler shift to be determined independently of whether the received audio chirp signal and replica audio chirp signal are time-aligned. For example, this may be achieved by, prior to the received audio chirp signal being transmitted, transmitting a calibration chirp signal. At this time, the transmitter and receiver are not time-synchronised with respect to the chirp signals. The calibration chirp signal is transmitted and received without any relative movement of the transmitter and receiver towards or away from each other. In other words, the received calibration chirp signal is not Doppler shifted. The calibration chirp signal is correlated with a replica audio chirp signal as described above to form a correlation output. The correlation peak index of the maximum amplitude correlation peak would be at correlation peak index 0 if the calibration chirp signal and the replica audio chirp signal were time aligned. The actual correlation peak index of the maximum amplitude correlation peak is used to alter the start sample time of the subsequently received audio chirp signal, such that the received audio chirp signal and the replica audio chirp signal are time-aligned during correlation. Thus, if the correlation peak index of the maximum correlation peak of the correlation performed with the subsequently received audio chirp signal is not at correlation peak index 0, then that is because the received audio chirp signal is Doppler shifted relative to the transmitted audio chirp signal.

As described above, the received audio chirp signal may be correlated with each of a set of replica audio chirp signals. Each of the set of replica audio chirp signals has a different Doppler shift relative to the transmitted audio chirp signal. In this case, the replica audio chirp signal with which the received audio chirp signal is most highly correlated is identified. In other words, the correlation response having the correlation peak with the maximum amplitude is identified. The relative alignment of the received audio chirp signal and the identified replica audio chirp signal is identified. In other words, the correlation peak index of the correlation peak with the maximum amplitude is identified. The Doppler shift corresponding to that relative alignment is then determined to be the Doppler shift of the received audio chirp signal.

The steps of the method of FIG. 8 may be implemented at the chirp receiver. Alternatively, the receiver may perform step 801 and then send the correlation results to another device for processing. Alternatively, the receiver may relay the received audio chirp signal to another device for processing, and that other device performs all of the steps of FIG. 8.

In an exemplary implementation, the received audio chirp signal is a received audio Zadoff-Chu chirp signal and the replica audio chirp signal(s) is a replica audio Zadoff-Chu chirp signal.

The determined Doppler shift provides a measure of the speed of relative motion of the transmitter and receiver in the direction of each other.

Relative movement of the transmitter and receiver of the audio chirp signal can be detected from the measured Doppler shift. Actions may then be taken in response to the measured Doppler shift. Consider, for example, a speaker system implementation such as that illustrated in FIG. 1. A mobile device transmits audio chirp signals which are received by a microphone in a speaker. The speaker is stationary. Movements of the mobile device are used to indicate actions to be taken by the speaker. In other words, a user gestures to the speaker to perform a particular action by moving the mobile device. The speaker stores instructions associated with the movements of the mobile device. The speaker determines the movement of the mobile device as described herein. The speaker then compares the determined movement to stored movements in the store. The speaker identifies a corresponding one of the stored movements that best matches the determined movement. The speaker reads from the store the instruction which corresponds to the identified stored movement. The speaker then performs the identified instruction.

As an example, the identified instruction may comprise modifying a parameter of the speaker. For example, the identified instruction may comprise modifying the volume at which the speaker plays out audio signals. Thus, if the speaker determines the mobile device to be moving towards it (due to a positive Doppler shift), then the speaker may respond by increasing the volume of the speaker. Conversely, if the speaker determines the mobile device to be moving away from it (due to a negative Doppler shift), then the speaker may respond by decreasing the volume of the speaker. Alternatively, if the speaker determines the mobile device to be moving towards it (due to a positive Doppler shift), then the speaker may respond by decreasing the volume of the speaker. Conversely, if the speaker determines the mobile device to be moving away from it (due to a negative Doppler shift), then the speaker may respond by increasing the volume of the speaker. The faster the mobile device is moved (i.e. the greater the magnitude of the Doppler shift), the greater the volume change implemented by the speaker.

The audio chirp signal may comprise a device identifier. The device identifier may be an identity of the device which sent the audio chirp signal. Alternatively, the device identifier may be an identity of the device which the audio chirp signal is addressed to. In the example above, the device identifier may identify the speaker whose volume is to change according to the gesture made by the mobile device. The device identity may be conveyed by a property of the audio chirp signal. For example, the device identity may be conveyed by the gradient of the audio chirp signal. The device identity may be conveyed by a sequence of gradients of the constituent chirps of an audio chirp signal. By including a device identifier, simultaneous unambiguous transmission of audio chirp signals may occur in the speaker system.

The speaker system may be a wireless speaker system which communicates according to Bluetooth wireless protocols.

In a further example, a speaker of the speaker system may transmit an audio chirp signal which is received by a microphone device. The speakers of the speaker system are stationary and their locations known. A user gestures to the speaker system by moving the microphone device. The audio chirp signal received by the microphone device is Doppler shifted by virtue of the microphone device's movement. The microphone device determines the Doppler shift of that audio chirp signal as described above. The microphone device may receive audio chirp signals from other speakers of the speaker system. The speakers may all send their audio chirp signals concurrently if each audio chirp signal includes a device identifier which identifies the speaker which transmitted it. Alternatively, the speakers may send their audio chirp signals one at a time, in an order known to the microphone device. In either case, the microphone device is able to identify which audio chirp signal, and hence which Doppler shift, is associated with which speaker. Each speaker sends a plurality of audio chirp signals. 3D gestures made by the microphone device can then be determined from the Doppler shifts of each of the received audio chirp signals and the known locations of the speakers.

The above paragraph describes the microphone device as carrying out the analysis of the received audio chirp signals. Alternatively, this analysis may partially or wholly be carried out by another device.

In another example, the determined Doppler shift between a transmitter and a receiver may be used to improve subsequent communications between those two devices. For example, the receiver may correct a subsequently received audio chirp signal for the determined Doppler shift. The parameters of that subsequently received audio chirp signal are then able to more accurately be determined This is useful, for example, if that subsequently received audio chirp signal is used in a location determining process. This is because the distance to the transmitter can be more accurately determined from a Doppler-corrected signal than from a Doppler-affected signal.

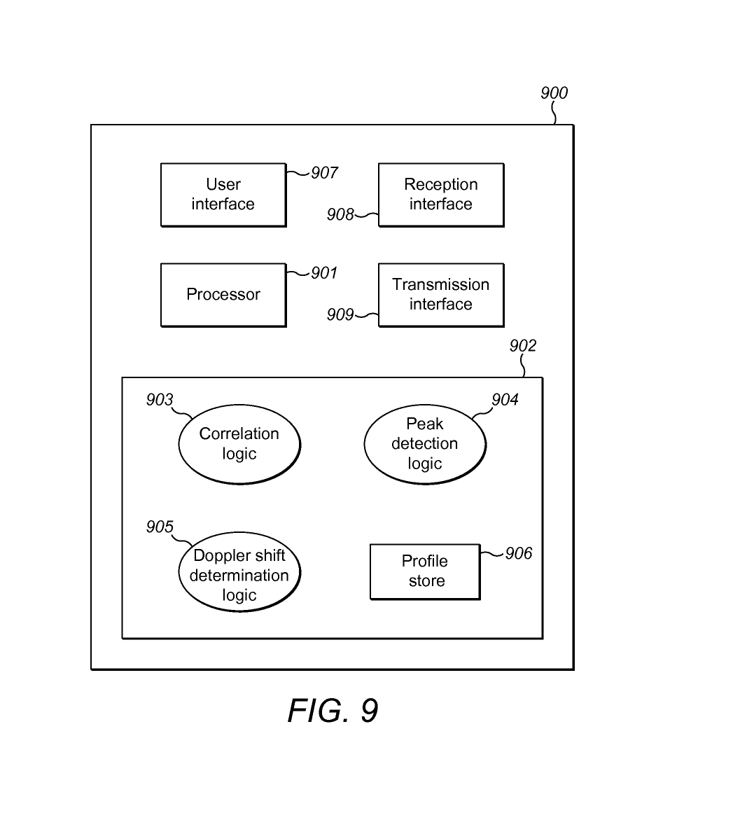

Reference is now made to FIG. 9. FIG. 9 illustrates a computing-based device 900 in which the described receiver can be implemented. The computing-based device may be an electronic device. The computing-based device illustrates functionality used for correlating received audio chirp signals, detecting correlation peaks in those correlations, and determining Doppler shift of those received audio chirp signals.

Computing-based device 900 comprises a processor 901 for processing computer executable instructions configured to control the operation of the device in order to perform the Doppler shift determination method. The computer executable instructions can be provided using any non-transient computer-readable media such as memory 902. Further software that can be provided at the computer-based device 900 includes correlation logic 903 which implements step 801 of FIG. 8, peak detection logic 904 which implements step 902 of FIG. 8, and Doppler shift determination logic 905 which implements step 803 of FIG. 8. Alternatively, the receiver for performing the correlation, peak detection and Doppler shift determination are implemented partially or wholly in hardware. Store 906 stores the correlator peak index/Doppler shift profile. Computing-based device 900 may optionally further include a user interface 907. The user interface 907 may be, for example, a touch screen, one or more buttons, a microphone for receiving voice commands, a camera for receiving user gestures, a peripheral device such as a mouse, etc. The computing-based device 900 also comprises a reception interface 908. The computing-based device optionally further comprises a transmission interface 909. The transmitter and receiver collectively include an antenna, radio frequency (RF) front end and a baseband processor. In order to transmit signals the processor 901 can drive the RF front end, which in turn causes the antenna to emit suitable RF signals. Signals received at the antenna can be pre-processed (e.g. by analogue filtering and amplification) by the RF front end, which presents corresponding signals to the processor 901 for decoding.

FIG. 7 is a schematic diagram showing exemplary components of a receiver according to the methods described herein. This figures illustrates the layout of the receiver in terms of functional boxes. The operations of one or more of these functional boxes may be combined. FIG. 7 does not illustrates those conventional components of a receiver known to a person skilled in the art.

The applicant draws attention to the fact that the present invention may include any feature or combination of features disclosed herein either implicitly or explicitly or any generalisation thereof, without limitation to the scope of any of the present claims. In view of the foregoing description it will be evident to a person skilled in the art that various modifications may be made within the scope of the invention.

1. A method of determining Doppler shift of a received audio chirp signal, the received audio chirp signal having a receive frequency profile Doppler shifted relative to a transmit frequency profile that the received audio chirp signal was transmitted with, the method comprising:
correlating the received audio chirp signal with a replica audio chirp signal to form a correlation output;
identifying a relative alignment of the received audio chirp signal and the replica audio chirp signal to be that at which the received audio chirp signal and the replica audio chirp signal are most highly correlated; and
determining the Doppler shift to be that corresponding to the identified relative alignment.

2. A method as claimed in claim 1, wherein the received audio chirp signal comprises a Zadoff-Chu code, and wherein the replica audio chirp signal comprises a Zadoff-Chu code.

3. A method as claimed in claim 1, comprising:
storing a model profile, the model profile associating a Doppler shift with each relative alignment between a received audio chirp signal and a replica audio chirp signal; and
determining the Doppler shift based on the model profile.

4. A method as claimed in claim 1, the received audio chirp signal having a gradient and a number of samples N, the method comprising:
identifying the relative alignment of the received audio chirp signal and the replica audio chirp signal to be the correlation peak index of the largest correlation peak in the correlation output; and
determining the Doppler shift by multiplying the correlation peak index by the gradient modulo N.

5. A method as claimed in claim 1, the received audio chirp signal having a gradient and a number of samples N, the method comprising:
identifying the relative alignment of the received audio chirp signal and the replica audio chirp signal by:
identifying a primary group of correlation peak indices comprising the largest correlation peak in the correlation output;
identifying neighbouring groups of correlation peak indices adjacent to the primary group of correlation peak indices;
determining a fractional Doppler shift from the magnitude of the largest correlation peak in the primary group and the magnitudes of the largest correlation peaks in the neighbouring groups;
determining an integer Doppler shift by multiplying the correlation peak index of the largest correlation peak in the primary group by the gradient modulo N; and
determining the Doppler shift by adding the fractional Doppler shift to the integer Doppler shift.

6. A method as claimed in claim 1, wherein the replica audio chirp signal has the transmit frequency profile.

7. A method as claimed in claim 1, wherein the replica audio chirp signal has a frequency profile shifted from the transmit frequency profile.

8. A method as claimed in claim 1, comprising:
correlating the received audio chirp signal with a plurality of replica audio chirp signals, each replica audio chirp signal having a frequency profile shifted from the other replica audio chirp signals;
identifying the replica audio chirp signal with which the received audio chirp signal is most highly correlated;
identifying the relative alignment of the received audio chirp signal and the identified replica audio chirp signal which are most highly correlated; and
determining the Doppler shift to be the Doppler shift corresponding to the identified replica audio chirp signal and the identified relative alignment.

9. A method as claimed in claim 1, further comprising prior to receiving the received audio chirp signal:
receiving a non-Doppler shifted calibration chirp signal;
correlating the non-Doppler shifted calibration chirp signal with a replica chirp signal to form a calibration correlation output;
adjusting the timing with which subsequent chirp signals are sampled based on the calibration correlation output such that if a subsequent chirp signal is not Doppler-shifted, then when that subsequent chirp signal is correlated against a replica chirp signal the largest correlation peak of that correlation is at a known correlation peak index.

10. A method as claimed in claim 1, further comprising detecting movement of a transmitter relative to a receiver from the Doppler shift.

11. A method as claimed in claim 10, further comprising:
storing instructions associated with movements;
comparing the detected movement of the transmitter to the movements in the store, thereby identifying a corresponding instruction; and
performing the identified instruction.

12. A method as claimed in claim 11, wherein performing the identified instruction comprises modifying a parameter of the receiver.

13. A method as claimed in claim 11, wherein performing the identified instruction comprises modifying the volume at which the receiver plays out audio signals.

14. A method as claimed in claim 1, wherein the received audio chirp signal comprises a chirp identifier which identifies the device which transmitted the received audio chirp signal.

15. A method as claimed in claim 1, further comprising correcting a subsequently received audio chirp signal for the determined Doppler shift to form a Doppler-corrected subsequently received audio chirp signal.

16. A method as claimed in claim 15, further comprising determining the distance between the device which transmitted the subsequently received audio chirp signal and the device which received the subsequently received audio chirp signal using the Doppler-corrected subsequently received audio chirp signal.

17. A chirp device configured to determine the Doppler shift of a received audio chirp signal, the received audio chirp signal having a receive frequency profile Doppler shifted relative to a transmit frequency profile that the received audio chirp signal was transmitted with, the chirp device configured to:
correlate the received audio chirp signal with a replica audio chirp signal to form a correlation output;
identify a relative alignment of the received audio chirp signal and the replica audio chirp signal to be that at which the received audio chirp signal and the replica audio chirp signal are most highly correlated; and
determine the Doppler shift to be that corresponding to the identified relative alignment.

18. A chirp device as claimed in claim 17, further comprising a model profile store configured to store a model profile associating a Doppler shift with each relative alignment between a received audio chirp signal and a replica audio chirp signal, the chirp device being configured to determine the Doppler shift based on the model profile.

19. A chirp device as claimed in claim 17, configured to:
identify the relative alignment of the received audio chirp signal and the replica audio chirp signal to be the correlation peak index of the largest correlation peak in the correlation output, the received audio chirp signal having a gradient and a number of samples N; and
determine the Doppler shift by multiplying the correlation peak index by the gradient modulo N.

20. A chirp device as claimed in claim 16, further configured to detect movement of a transmitter relative to a receiver by determining the Doppler shifts of each of a set of further received audio chirp signals transmitted by the transmitter and received at the receiver.
